(19) United States
(12) Patent Application Publication
(10) Pub. No.: US 2007/0297194 A1
(43) Pub. Date: Dec. 27, 2007

(54) Backlight module

(75) Inventor: Chih-Chia Tsai, Taichung County (TW)

Correspondence Address: BIRCH STEWART KOLASCH & BIRCH, PO BOX 747, FALLS CHURCH, VA, 22040-0747, US

(73) Assignee: Benq Corporation

(21) Appl. No.: 11/812,044

(22) Filed: Jun. 14, 2007

(30) Foreign Application Priority Data
Jun. 23, 2006 (TW) 95122812

(51) Int. Cl. F21V 7/04

(52) U.S. Cl. 362/621

(57) ABSTRACT

A backlight module includes a light source, a light guide plate, and a reflection film is provided. The light guide plate has alight-incident surface, a first light-emitting surface, and a second light-emitting surface. The light emitted by the light source enters the light guide plate via the light-incident surface, then is emitted out from the light guide plate via the first light-emitting surface and the second light-emitting surface. The reflection film is able to move between a first location and a second location. The reflection film is adjacent to the first light-emitting surface of the light guide plate for reflecting the light emitted from the first light-emitting surface while the reflection film is at the first location, and the light reflected by the reflection film is emitted out from the second light-emitting surface. On the other side, the reflection film is away from the first light-emitting surface of the light guide plate for permitting the light emitted from the first light-emitting surface while the reflection film is at the second location. A mobile phone using the backlight module may have an illumination function.

### BACKGROUND OF THE INVENTION

(1) Field of the Invention

The invention relates to a light source module, more particularly to a backlight module, and an LCD and a mobile phone with illumination function applied the above backlight module.

(2) Description of the Prior Art

Following the advancement of the wireless communication and the information processing technology, the mobile phone, personal digital assistant (PDA), and the other portable electronic devices emerge in large numbers, which makes consumers enjoy the conveniences from the high technologies in any time and anyplace. Moreover, since the mobile phone has great portability, the mobile phone with flashlight function is developed, which can occasionally provide the light to the user for illumination.

However, the present mobile phone with illumination function has two light sources to provide the light for illumination and the light for displaying image in the display panel respectively, such as U.S. Pat. Nos. 6,755,549, 6,474,828, and 6,341,871. But the above manner not only makes the manufacturing cost hardly be lowered, but also obstructs the function integration of the mobile phone.

### SUMMARY OF THE INVENTION

An objective of the present invention is to provide a backlight module. The backlight module can selectively change the exiting direction of the light to provide the user needed light in different situations.

Another objective of the present invention is to provide a mobile phone with illumination function. The present invention can transfer the surface source of the display monitor into the point source with illumination function, thereby to improve the utilization of light.

Another objective of the present invention is to provide an LCD. The LCD includes the above backlight module so as to have the illumination function.

According to the above objectives and the other objectives, the present invention provides a backlight module comprising a light source, a light guide plate, and a reflection film. The light guide plate has a first light-emitting surface, a second light-emitting surface, and a light-incident surface. The light from the light source enters the light guide plate via the light-incident surface, and then is emitted out from the light guide plate via the first light-emitting surface and the second light-emitting surface.

The reflection film is able to move between a first location and a second location. The reflection film is adjacent to the first light-emitting surface for reflecting the light emitted from the first light-emitting surface toward the light guide plate while the reflection film is at the first location. And then the light reflected by the reflection film is emitted out from the second light-emitting surface.

On the other side, the reflection film is away from the first light-emitting surface for permitting the light entered the light guide plate to emit from the first light-emitting surface while the reflection film is at the second location.

The present invention provides a mobile phone with illumination function, and the mobile phone at least comprises a body and the above backlight module. The body has a display panel and a lighting hole. The first light-emitting surface of the light guide plate is corresponding to the display panel, and the second light-emitting surface is corresponding to the lighting hole.

The present invention provides an LCD, and the LCD at least comprises a housing, a display panel, and the above backlight module. The display panel and backlight module are disposed inside the housing. The housing has a lighting hole and a display panel opening, and the second light-emitting surface of the light guide plate is corresponding to the lighting hole. The display panel is located above the first light-emitting surface of the light guide plate, and the display panel is exposed via the display panel opening.

In one embodiment of the present invention, the above backlight module further comprises a first transmission shaft. The first transmission shaft is linked up with the reflection film and drives the reflection film to move between the first location and the second location. When the first transmission shaft is located at the second location, the reflection film is wound around the first transmission shaft.

In one embodiment of the present invention, the above backlight module further comprises a guide rail. The guide rail is disposed above the first light-emitting surface for guiding the reflection film toward the first location.

In one embodiment of the present invention, the above backlight module further comprises a diffusion film. The diffusion film is disposed above the first light-emitting surface of the light guide plate for scattering the light exited from the first light-emitting surface to become the uniform surface source.

In one embodiment of the present invention, the above backlight module further comprises a diffusion film. The diffusion film is linked up with the reflection film. The diffusion film is driven and disposed above the first light-emitting surface of the light guide plate by the reflection film while the reflection film is moved to the second location.

In one embodiment of the present invention, the above backlight module further comprises a condensing component. The condensing component is disposed in front of the second light-emitting surface of the light guide plate for gathering the light exited via the second light-emitting surface.

The backlight module of the present invention has two light-emitting surfaces, and the user can choose the exiting direction of the light offered by the backlight module according to the requirement. Therefore, when the backlight module of the present invention is applied to the mobile phone or the LCD, the backlight module not only provides the needed light for displaying image, but also provides the light for illuminating, so that the mobile phone and the LCD have illumination function.

These and the other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

The present invention will now be specified with reference to its preferred embodiment illustrated in the drawings, in which:

FIG. 1A illustrating a cross-sectional view of a first embodiment of a backlight module of the present invention;

FIG. 1B illustrating a cross-sectional view of the backlight module of FIG. 1A as a reflection film is at a second location;

FIG. 2A illustrating a cross-sectional view of a second embodiment of the backlight module of the present invention;

FIG. 2B illustrating a cross-sectional view of the backlight module of FIG. 2A as a reflection film is at a second location;

FIG. 3 illustrating a schematic view of a mobile phone with illumination function of the present invention; and

FIG. 4 illustrating a schematic view of an LCD of the present invention.

### DESCRIPTION OF THE PREFERRED EMBODIMENT

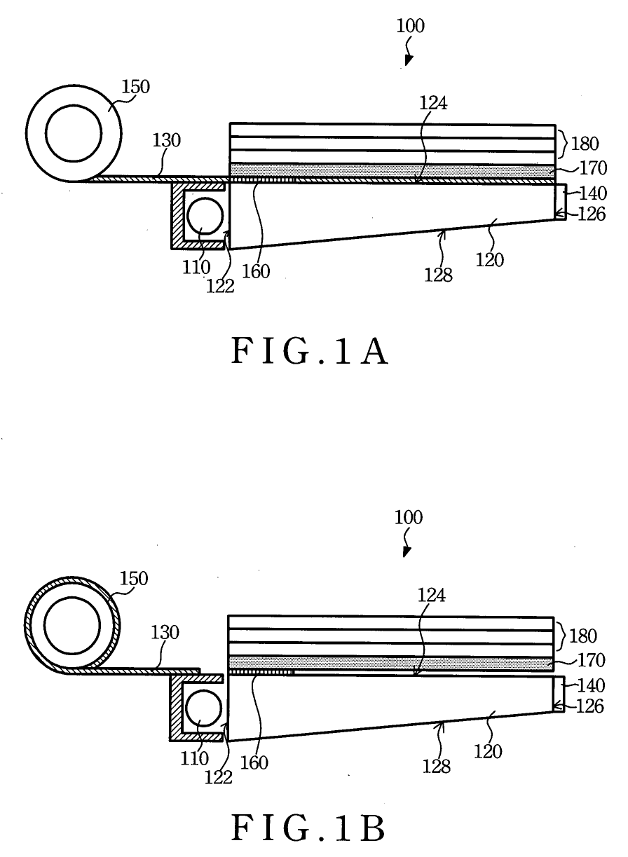

Please refer to FIG. 1A, which illustrates a cross-sectional view of a first embodiment of a backlight module of the present invention. The backlight module 100 mainly comprises a light source 110, a light guide plate 120, and a reflection film 130.

The light guide plate 120 has a first light-emitting surface 124, a second light-emitting surface 126, and a light-incident surface 122. The light from the light source 110 enters the light guide plate 120 via the light-incident surface 122, and then is emitted out from the light guide plate 120 via the first light-emitting surface 124 and the second light-emitting surface 126. People who are skilled in the art should know that the above backlight module 100 is the edge-type backlight module, that is, the light source 110 is disposed beside the light-incident surface 122 of the light guide plate 120.

Please still refer to FIG. 1A, the reflection film 130 is able to move between a first location and a second location. Detailed description as following, the reflection film 130 is adjacent to the first light-emitting surface 124 of the light guide plate 120 while the reflection film is at the first location. In this embodiment, the reflection film 130 is above the first light-emitting surface 124 for reflecting the light emitted from the first light-emitting surface 124 toward the light guide plate 120.

Besides, the light guide plate 120 has a reflecting surface 128 corresponding to the first light-emitting surface 124. Thus, when the reflection film 130 is at the first location, after the light enters the light guide plate 120 via the light-incident surface 122, the light is be reflected by the reflection film 130 and the reflecting surface 128 of the light guide plate 120, and then is emitted out from the second light-emitting surface 126.

In this embodiment, a condensing component 140 is disposed in front of the second light-emitting surface 126 for gathering the light exited via the second light-emitting surface 126 toward the same direction. Wherein, the condensing component 140 can be a brightness enhancement film (BEF) or a prism film, which can utilize the light effectively to improve the whole brightness and uniformity so as to achieve good brightness enhancement result.

Moreover, people who are skilled in the art should know that in order to improve the utilization of light, the surface of the light guide plate 120 corresponding to the first light-emitting surface 124 has reflection characteristic or a reflection film (not shown) is disposed under the light guide plate 120, thereby to achieve the same result.

Please refer to FIG. 1B, which illustrates a cross-sectional view of the backlight module of FIG. 1A as a reflection film is at a second location. The reflection film 130 is away from the first light-emitting surface 124 of the light guide plate 120 for permitting the light entered the light guide plate 120 to emit from the first light-emitting surface 124 while the reflection film 130 is at the second location.

In this embodiment, a diffusion film 170 and the other optical film are disposed above the first light-emitting surface 124 of the light guide plate 120, such as brightness enhancement film, prism film, etc. When the reflection film 130 is at the second location, the light offered by the light source 110 can be emitted from the first light-emitting surface 124 of the light guide plate 120, and pass through the diffusion film 170 and the optical film 180 in sequence.

It is noted that, the reflection film 130 is driven to move between the first location and the second location by a first transmission shaft 150 in the embodiment, wherein first transmission shaft 150 is located at the second location. Detailed description as following, when the reflection film 130 is at the second location, the light inside the light guide plate 120 will be emitted from the first light-emitting surface 124. At this time, the reflection film 130 is wound around the first transmission shaft 150.

On the other side, the first transmission shaft 150 can be rotated to drive the reflection film 130 to the first location, thereby to make the light inside the light guide plate 120 be emitted from the second light-emitting surface 126.

The reflection film 130 of this embodiment is guiding from the second location to the first location via a guide rail 160. Wherein, the guide rail 160 is disposed above the first light-emitting surface 124 of the light guide plate 120. Certainly, the reflection film 130 is driven by the first transmission shaft 150 from the first location to the second location.

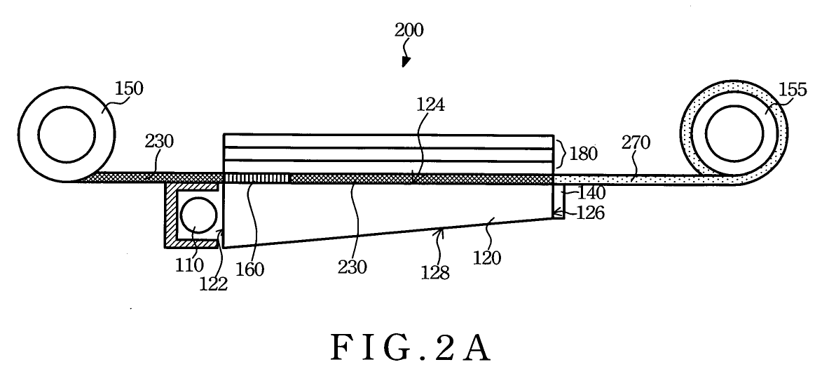

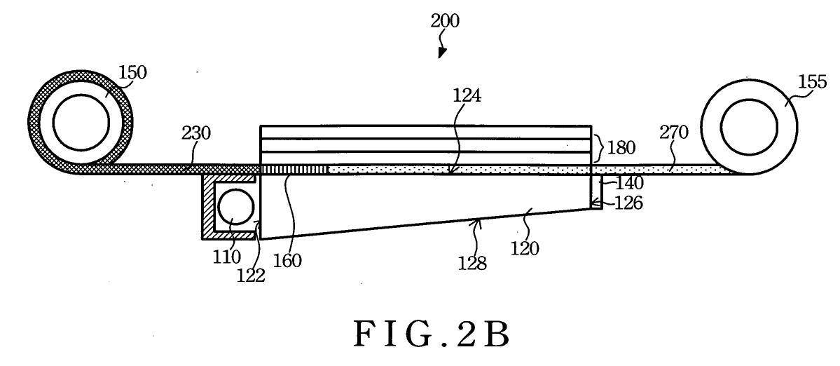

FIG. 2A illustrates a cross-sectional view of a second embodiment of the backlight module of the present invention. FIG. 2B illustrates a cross-sectional view of the backlight module of FIG. 2A as a reflection film is at a second location. Please refer to FIG. 2A and FIG. 2B, in the backlight module 200, a diffusion film 270 can be linked up with a reflection film 230 to become one film, thereby to reduce the whole thickness of the backlight module 200.

As shown in FIG. 2A, the diffusion film 270 is wound around a second transmission shaft 155 while the reflection film 230 is located above the first light-emitting surface 124 (first location). As shown in FIG. 2B, the diffusion film 270 is located above the first light-emitting surface 124 of the light guide plate 120 while the reflection film 230 is wound around the first transmission shaft 150 (second location).

It is noted that, in order to make the reflection film 230 and the diffusion film 270 move between the first location and the second location successfully, the first transmission shaft 150 and the second transmission shaft 155 are individually disposed near the light-incident surface 122 and the second light-emitting surface 126.

Wherein, the diffusion film 270 is wound around a second transmission shaft 155 while the reflection film 230 is at the first location. The reflection film 230 is wound around the first transmission shaft 150 while the diffusion film 270 is at the first location.

However, the invention is not limited that the optical film linked up with the reflection film 230 is the diffusion film 270. In another embodiment, the reflection film 230 also can be linked up with the other optical film, such as brightness enhancement film, prism film, etc.

The backlight module of the present invention can be applied to a mobile phone, so that the mobile phone has the illumination function. Detailed description is as following.

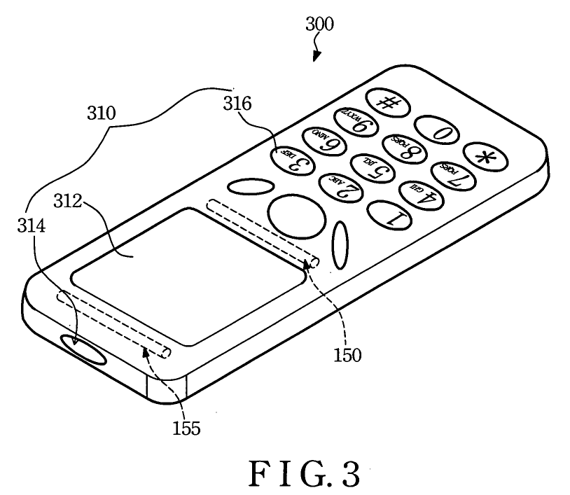

FIG. 3 illustrates a schematic view of the mobile phone with illumination function of the present invention. Please refer to FIG. 1A and FIG. 3, the mobile phone 300 at least comprises a body 310 and the backlight module 100 (not shown in FIG. 3).

It is noted that, although the embodiment takes the backlight module 100 as an example, the backlight module of the mobile phone 300 also can be the backlight module 200 of FIG. 2, or any backlight module mentioned above in practice.

Please refer to FIG. 1A, FIG. 2A, and FIG. 3, the body 310 at least comprises a display panel 312, a lighting hole 314, and keypad 316. The backlight module is located under the display panel 312, the first light-emitting surface 124 of the light guide plate 120 is corresponding to the display panel 312, and the second light-emitting surface 126 is corresponding to the lighting hole 314.

The first transmission shaft 150 and the second transmission shaft 155 are respectively disposed near the upper side of display panel 312 and near the below side of display panel 312 and extended inside the body 310.

Thus, when the reflection film 130 [symbol] 230 is at the first location, after the light from the light source 110 enters the light guide plate 120 via the light-incident surface 122, the light is be reflected by the reflection film 130 [symbol] 230 and the reflecting surface 128 of the light guide plate 120. Then, the light is emitted out from the second light-emitting surface 126 and passes through the condensing component 140. Finally, the light is emitted via the lighting hole 314. In other words, the backlight module 100 can provide the needed light for illumination.

Please refer to FIG. 1B, FIG. 2B, and FIG. 3, when the reflection film 130 [symbol] 230 is at the second location, after the light from the light source 110 enters the light guide plate 120 via the light-incident surface 122, the light is emitted out from the light guide plate 120 via the first light-emitting surface 124 so as to provide the display panel 312 with the needed light for displaying image.

As described above, the reflection film 130 [symbol] 230 is driven to move between the first location and the second location by the first transmission shaft 150. In one embodiment, the first transmission shaft 150 is driven by a vibrator (not shown in figure), wherein the vibrator is disposed inside the body 310 for providing vibration function.

Therefore, when the user wants to utilize the mobile phone 300 to provide the needed light for illumination, the user can input the command to the mobile phone 300, thereby to drive the first transmission shaft 150 to rotate, and then the reflection film 130 [symbol] 230 is moved to the first location.

It is noted that, the light provided from the light source 110 can not be emitted to the display panel 312 while the reflection film 130 [symbol] 230 is at the first location, thus when the display panel 312 needs to display the image, the first transmission shaft 150 needs to be driven again to move the reflection film 130 [symbol] 230 from the first location to the second location.

Besides, the backlight module of the present invention also can be applied to the clam shell mobile phone, which is not limited the mobile phone type of the above figure.

Similarly, the backlight module of the present invention also can be applied to an LCD, so that the LCD has illumination function.

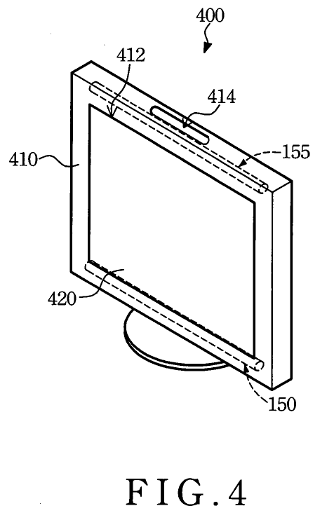

FIG. 4 illustrates a schematic view of the LCD of the present invention. Please refer to FIG. 4, the LCD 400 at least comprises a housing 410, a display panel 420 and any of the above backlight module, wherein the following paragraph takes the backlight module 100 [symbol] 200 of FIG. 1A or FIG. 2A for example.

Please refer to FIG. 1A, FIG. 2A, and FIG. 4, the display panel 420 and backlight module 100 [symbol] 200 are disposed inside the housing 410, and the display panel 420 is located above the first light-emitting surface 124 of the light guide plate 120.

The first transmission shaft 150 and the second transmission shaft 155 are respectively disposed at both sides of the display panel 420, and be extended at top side and bottom side of the display panel 420. The housing 410 has a lighting hole 414 and a display panel opening 412, wherein the area for displaying image of the display panel 420 is exposed via the display panel opening 412, and the lighting hole 414 is corresponding to the second light-emitting surface 126 of the light guide plate 120.

The above LCD 400 is similar to the mobile phone of FIG. 3, the LCD 400 of the embodiment has the illumination function. The detailed motion is as the above mention, and unnecessary detail is not given again.

As stated above, the backlight module of the present invention can change the exiting direction of the light via the reflection film above the light guide plate, so that the mobile phone, the LCD, and the other device applied the backlight module have the illumination function. In other words, the mobile phone, the LCD, and the other device applied the backlight module can utilize the backlight module to provide the needed light for illumination directly, and do not need any additional light source for illumination. Therefore, the manufacturing cost is low and the function integration of the whole device is more easy.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A backlight module, comprising:
a light guide plate having a first light-emitting surface, a second light-emitting surface, and a light-incident surface;
a light source for emitting light, wherein said light enters said light guide plate via said light-incident surface, and then is emitted out from said light guide plate via said first light-emitting surface and said second light-emitting surface; and
a reflection film being able to move between a first location and a second location, wherein said reflection film is adjacent to said first light-emitting surface for reflecting said light emitted from said first light-emitting surface toward said light guide plate while said reflection film is at said first location, and said light reflected by said reflection film is emitted out from said second light-emitting surface, and said reflection film is away from said first light-emitting surface for permitting said light entered said light guide plate to emit from said first light-emitting surface while said reflection film is at said second location.

2. The backlight module of claim 1, wherein said backlight module further comprises a first transmission shaft, said first transmission shaft is linked up with said reflection film and drives said reflection film to move between said first location and said second location.

3. The backlight module of claim 2, wherein said first transmission shaft is located at said second location, and said reflection film can be wound around said first transmission shaft.

4. The backlight module of claim 1, wherein said backlight module further comprises a guide rail disposed above said first light-emitting surface for guiding said reflection film toward said first location.

5. The backlight module of claim 1, wherein said backlight module further comprises a diffusion film disposed above said first light-emitting surface.

6. The backlight module of claim 1, wherein said backlight module further comprises a diffusion film linked up with said reflection film, said diffusion film is driven and disposed above said first light-emitting surface by said reflection film while said reflection film is moved to said second location.

7. The backlight module of claim 1, wherein said backlight module further comprises a condensing component disposed in front of said second light-emitting surface of said light guide plate.

8. A mobile phone with illumination function, comprising:
a body having a display panel and a lighting hole;
a backlight module being disposed inside said body, said backlight module comprising:
a light guide plate having a first light-emitting surface, a second light-emitting surface, and a light-incident surface, wherein said first light-emitting surface is corresponding to said display panel, said second light-emitting surface is corresponding to said lighting hole;
a light source for emitting light, wherein said light enters said light guide plate via said light-incident surface, and then is emitted out from said light guide plate via said first light-emitting surface and said second light-emitting surface; and
a reflection film being able to move between a first location and a second location, wherein said reflection film is adjacent to said first light-emitting surface for reflecting said light emitted from said first light-emitting surface toward said light guide plate while said reflection film is at said first location, and said light reflected by said reflection film is emitted out from said second light-emitting surface, and said reflection film is away from said first light-emitting surface for permitting said light entered said light guide plate to emit from said first light-emitting surface while said reflection film is at said second location.

9. The mobile phone of claim 8, wherein said mobile phone further comprises a condensing component disposed in front of said second light-emitting surface of said light guide plate.

10. The mobile phone of claim 8, wherein said backlight module further comprises a first transmission shaft, said first transmission shaft is linked up with said reflection film and drives said reflection film to move between said first location and said second location.

11. The mobile phone of claim 10, wherein said first transmission shaft is located at said second location, and said reflection film can be wound around said first transmission shaft.

12. The mobile phone of claim 8, wherein said backlight module further comprises a guide rail disposed above said first light-emitting surface for guiding said reflection film toward said first location.

13. The mobile phone of claim 8, wherein said backlight module further comprises a diffusion film disposed above said first light-emitting surface.

14. The mobile phone of claim 8, wherein said backlight module further comprises a diffusion film linked up with said reflection film, said diffusion film is driven and disposed above said first light-emitting surface by said reflection film while said reflection film is moved to said second location.

15. A liquid crystal display comprising:
a housing having a lighting hole and a display panel opening;
a backlight module being disposed inside said housing, said backlight module comprising:
a light guide plate having a first light-emitting surface, a second light-emitting surface, and a light-incident surface, wherein said second light-emitting surface is corresponding to said lighting hole of said housing;
a light source for emitting light, wherein said light enters said light guide plate via said light-incident surface, and then is emitted out from said light guide plate via said first light-emitting surface and said second light-emitting surface;
a reflection film being able to move between a first location and a second location, wherein said reflection film is adjacent to said first light-emitting surface for reflecting said light emitted from said first light-emitting surface toward said light guide plate while said reflection film is at said first location, and said light reflected by said reflection film is emitted out from said second light-emitting surface, and said reflection film is away from said first light-emitting surface for permitting said light entered said light guide plate to emit from said first light-emitting surface while said reflection film is at said second location; and
a display panel being disposed inside said housing and located above said first light-emitting surface of said light guide plate, and said display panel is exposed via said display panel opening.

16. The liquid crystal display of claim 15, wherein said backlight module further comprises a first transmission shaft, said first transmission shaft is linked up with said reflection film and drives said reflection film to move between said first location and said second location.

17. The liquid crystal display of claim 16, wherein said first transmission shaft is located at said second location, and said reflection film can be wound around said first transmission shaft.

18. The liquid crystal display of claim 15, wherein said backlight module further comprises a guide rail disposed above said first light-emitting surface for guiding said reflection film toward said first location.

19. The liquid crystal display of claim 15, wherein said backlight module further comprises a diffusion film disposed above said first light-emitting surface.

20. The liquid crystal display of claim 15, wherein said backlight module further comprises a diffusion film linked up with said reflection film, said diffusion film is driven and disposed above said first light-emitting surface by said reflection film while said reflection film is moved to said second location.

21. The liquid crystal display of claim 15, wherein said backlight module further comprises a condensing component disposed in front of said second light-emitting surface of said light guide plate.
